(19) United States
(12) Patent Application Publication
(10) Pub. No.: US 2025/0249951 A1
(43) Pub. Date: Aug. 7, 2025

(54) STEERING CONTROL DEVICE AND METHOD

(71) Applicant: HL MANDO CORPORATION, Gyeonggi-do (KR)

(72) Inventor: Jung Yeol KIM, Gyeonggi-do (KR)

(21) Appl. No.: 18/781,996

(22) Filed: Jul. 23, 2024

(30) Foreign Application Priority Data
Feb. 1, 2024 (KR) 10-2024-0016075

(51) Int. Cl. B62D 5/04; B62D 6/00; B62D 15/02

(52) U.S. Cl. CPC B62D 5/046; B62D 6/00; B62D 15/021

(57) ABSTRACT

The disclosure relates to a steering control device and method. Specifically, a steering control device according to the disclosure comprises a receiver receiving a steering angle of a steering wheel from a steering angle sensor, a torque calculator calculating a soft end stop (SES) torque in a direction opposite to steering of the steering wheel when the steering angle enters an SES torque output section, and a controller outputting a control signal for adjusting a final torque applied to a steering motor based on the SES torque.

### CROSS-REFERENCE TO RELATED APPLICATION

This application claims priority from Korean Patent Application No. 10-2024-0016075, filed on Feb. 1, 2024, which is hereby incorporated by reference for all purposes as if fully set forth herein.

### BACKGROUND

### Field

The present embodiments relate to a steering control device and method for assisting a driver's steering.

### Description of Related Art

A conventional vehicle steering device is a device for the driver to choose the vehicle's traveling direction and perform manipulation and includes a steering wheel, which is directly manipulated by the driver, and a steering mechanism for transferring the handling direction and force of the steering wheel to the vehicle wheels.

For example, power steering devices have been developed and applied to provide driving convenience in aid of the handling force of the steering wheel and include hydraulic types using hydraulic pressure, electric-hydraulic types using both hydraulic pressure and motor electromotive force, and electric types using motor electromotive force alone, which have been sequentially developed and applied.

In general, an electric power steering (EPS) device has a steering motor installed on the steering wheel shaft, and when the vehicle is started, the steering motor operates to enable power steering. This reduces the force for the driver to manipulate the steering according to the velocity of the vehicle, thereby enabling light and rapid steering manipulation.

In the electric power steering control logic, when the steering wheel rotates and touches the end stopper which is a mechanism for limiting the maximum rotation of the steering wheel, a high torsion torque may be generated to generate a maximum motor current, causing damage to the mechanism.

Accordingly, there is ongoing research for mitigating noise and vibration generated when the steering wheel collides with the end stopper.

### BRIEF SUMMARY

In the foregoing background, the disclosure provides a steering control device and method for adjusting a final torque applied to a steering motor by calculating an SES torque when the steering angle of the steering wheel enters a torque output section.

To achieve the foregoing objectives, in an aspect, the disclosure provides a steering control device comprising a receiver receiving a steering angle of a steering wheel from a steering angle sensor, a torque calculator calculating a soft end stop (SES) torque in a direction opposite to steering of the steering wheel if the steering angle enters an SES torque output section, and a controller outputting a control signal for adjusting a final torque applied to a steering motor based on the SES torque.

In another aspect, the disclosure provides a steering control method comprising an information reception step receiving a steering angle of a steering wheel from a steering angle sensor, a torque calculation step calculating a soft end stop (SES) torque in a direction opposite to steering of the steering wheel if the steering angle enters an SES torque output section, and a control step outputting a control signal for adjusting a final torque applied to a steering motor based on the SES torque.

As described above, according to the disclosure, the steering control device and method may output the SES torque applied at a uniform position at the steering end of the steering wheel.

Further, according to the disclosure, it is possible to apply a large SES torque in a direction opposite to the steering from the steering end of the steering wheel.

### DESCRIPTION OF DRAWINGS

The above and other objects, features, and advantages of the present disclosure will be more clearly understood from the following detailed description, taken in conjunction with the accompanying drawings, in which:

FIG. 1 is a view schematically illustrating a steering assistance system according to the disclosure;

FIG. 2 is a view illustrating a final torque applied to a steering motor;

FIG. 3 is a view illustrating a normal SES torque;

FIG. 4 is a block diagram schematically illustrating a steering control device according to an embodiment of the disclosure;

FIG. 5 is a view illustrating an example of calculating an SES torque according to an embodiment;

FIG. 6 is a view illustrating an angle-based torque amount according to a steering angle according to an embodiment;

FIG. 7 is a view illustrating an example of restoring an SES torque when a steering wheel is released at an end according to an embodiment;

FIG. 8 is a view illustrating an example of varying a weight torque according to a reverse condition of a steering wheel according to an embodiment;

FIG. 9 is a block diagram illustrating a steering control device according to another embodiment of the disclosure; and

FIG. 10 is a flowchart illustrating a steering control method according to an embodiment of the disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, an embodiment of a steering control system 1 that may perform the function of a steering control device 10 and the function of controlling the steering of the vehicle is described.

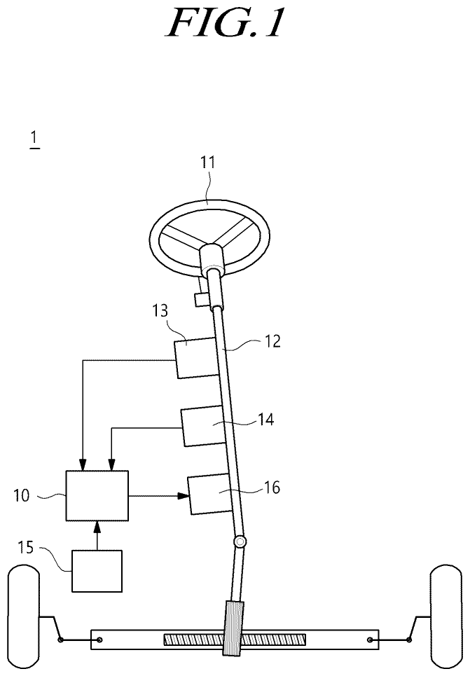

FIG. 1 is a view schematically illustrating a steering assistance system 1 according to the disclosure.

Referring to FIG. 1, a steering assistance system 1 according to the disclosure may include a steering controller 10, a steering wheel 11, a shaft 12, a steering angle sensor 13, a torque sensor 14, a velocity sensor 15, and a steering motor 16.

The steering wheel 11 may be rotated by the user's manipulation. The steering wheel 11 may be coupled to the shaft 12. The shape of the steering wheel 11 may be circular as shown in FIG. 1, but is not limited thereto.

The shaft 12 may be coupled to the steering wheel 11 and rotated together with the steering wheel 11. The shape of the shaft 12 may be a cylindrical shape.

Although not shown, the shaft 12 may include a plurality of reducers, and any one of the plurality of reducers may be coupled to the outer circumstantial surface of the shaft 12.

Although not shown, the steering assistance device 100 according to the disclosure may have a steering column including a shaft 12 and a reducer.

The steering angle sensor 13 may detect the steering angle generated by the rotation of the steering wheel 11. The steering angle sensor 13 may output a steering angle signal indicating information about the steering angle.

Here, the steering angle generally may not be detected if the steering wheel 11 does not rotate, and the corresponding steering angle signal may not be output if the steering wheel 11 does not rotate.

The torque sensor 14 may detect a steering torque generated by rotation of the steering wheel 11. When the steering torque is detected, the torque sensor 14 may output a steering torque signal indicating information about the steering torque.

The steering torque may mean a torque applied to the torsion bar present between the input axis and the output axis of the shaft 12. Therefore, the steering torque may be detected even when the steering wheel 11 is not rotated.

The velocity sensor 15 may detect the velocity of the vehicle and output a vehicle velocity signal indicating information about the vehicle velocity.

The steering motor 16 may receive a control signal from the steering control device 10 and drive at a torque and a rotational velocity according to a command current. Although not shown, the steering motor 16 may be coupled to a reducer disposed on the shaft 12. The reducer disposed on the shaft 12 and the shaft 120 may be rotated by the rotation of the steering motor 16.

When the steering control device 10 is configured as a redundant system having a plurality of steering control modules, the same number of steering motors 16 may be configured to be connected to the plurality of steering control modules, respectively. For example, when the steering control device 10 includes a first steering control module and a second steering control module, the steering motor 16 may include a first steering motor connected to the first steering control module and a second steering motor connected to the second steering control module.

Meanwhile, the shaft may be rotated due to the rotation of the steering motor 16, and the wheels may be moved left or right by the operation of the rack and pinion, thereby turning the vehicle. Further, the steering assistance system 1 may be configured to transfer the rotational motion of the steering motor 16 to the rack bar through a worm-wheel, and to move the wheels connected to the rack bar to the left or right.

The steering control device 10 may receive the steering angle signal output by the steering angle sensor 13, the steering torque signal output by the torque sensor 14, and the vehicle velocity signal output by the velocity sensor 15. The steering control device 10 may receive the steering angle signal and the steering torque signal to calculate a rack stroke for providing an assist torque, and output a control signal corresponding to the rack stroke to the steering motor 16. This assist torque is an example of the torque applied to the steering motor 16.

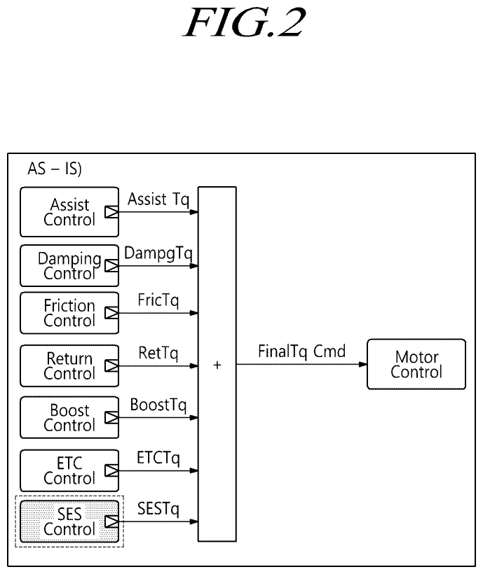

FIG. 2 is a view illustrating a final torque applied to a steering motor.

Referring to FIG. 2, the steering control device 10 may calculate a final torque considering all of the plurality of torques considering the steering environment, and output a control signal Final Tq Cmd corresponding to the final torque to the steering motor 16.

In an embodiment, the final torque Final Tq may be a value obtained by summating all of an assist torque Assis Tq corresponding to the assist control value, a damping torque Dampn Tq for mitigating collision of the steering wheel with two opposite ends of the steering area, a friction torque Fric Tq due to friction between mechanisms, a return torque Ret Tq due to reversion of the steering wheel, a boost torque Boost Tq, an SES torque SES Tq and an electronic throttle control (ETC) torque ETC Tq calculated and output in the disclosure. The steering control device 10 may receive sensor values from a plurality of sensors to calculate the respective torques described above.

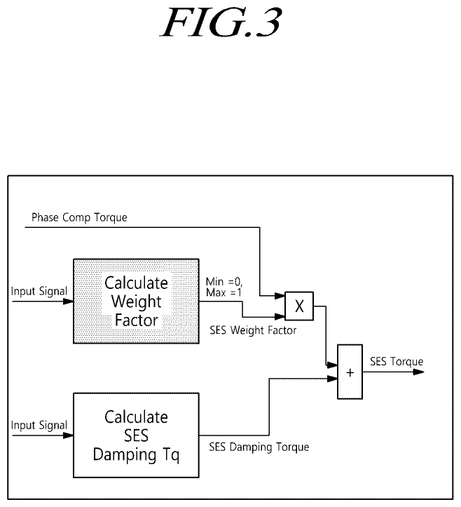

FIG. 3 is a view illustrating a normal SES torque.

Referring to FIG. 3, a general SES torque may be calculated as the sum of an SES damping torque Damping Tq and a weight factor. The weight factor may be calculated according to the SES entry angle of the steering angle of the steering wheel, or may be calculated by further considering the steering angular velocity of the steering wheel.

The calculated SES torque is generated non-linearly as the SES torque is determined by the weight factor, so that a uniform SES torque is not applied, and a large SES torque may not be applied to the steering end of the steering wheel.

Hereinafter, a steering control device 10 according to an embodiment of the disclosure for addressing the aforementioned shortcomings is described with reference to the accompanying drawings.

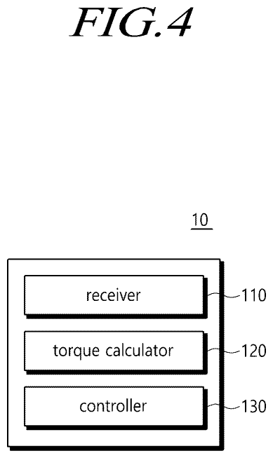

FIG. 4 is a block diagram schematically illustrating a steering control device 10 according to an embodiment of the disclosure.

Referring to FIG. 4, a steering control device 10 according to an embodiment of the disclosure may include a receiver 110, a torque calculator 120, and a controller 130.

The steering control device 10 according to an embodiment of the disclosure may be implemented in hardware and software, such as an electronic control unit (ECU) including a microcontroller unit (MCU), an inverter, and a printed circuit board (PCB).

The steering control device 10 may be an advanced driver assistance systems (ADAS) that provides information for assisting driving of the vehicle or provides assistance for controlling the vehicle.

Here, ADAS may refer to various types of advanced driver assistance systems and may include, e.g., autonomous emergency braking, smart parking assistance system (SPAS), blind spot detection (BSD), adaptive cruise control (ACC), lane departure warning system (LDWS), lane keeping assist system (LKAS), and lane change assist system (LCAS). However, embodiments of the disclosure are not limited thereto.

The steering control device 10 may receive the steering angle of the steering wheel from the steering angle sensor, and when the steering angle enters an soft end stop (SES) torque output section, calculate the SES torque in a direction opposite to the steering of the steering wheel, and output a control signal for adjusting the final torque applied to the steering motor based on the SES torque.

The receiver 110 may receive the steering angle of the steering wheel from the steering angle sensor. Further, the receiver 110 is not limited to the steering angle sensor, and may receive the sensor value from each of the plurality of sensors to receive the sensor values considered for calculating the SES torque. For example, the receiver 110 may receive the vehicle velocity of the host vehicle considered for the SES torque from the vehicle velocity sensor. As another example, the steering angular velocity value may be received from the steering angular velocity sensor.

When the steering angle enters the soft end stop (SES) torque output section, the torque calculator 120 may calculate the SES torque in a direction opposite to the steering of the steering wheel.

The torque output section may be set to a section spaced apart from a mechanical end steering angle by a predetermined angle at each of two opposite ends of the operating range of the steering wheel.

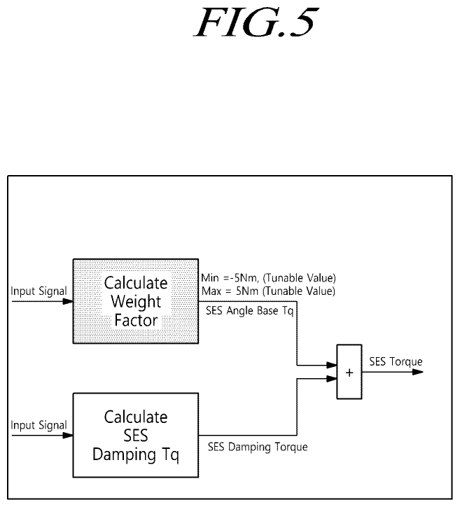

FIG. 5 is a view illustrating an example of calculating an SES torque according to an embodiment.

Referring to FIG. 5, the SES torque may be calculated as the sum of an angle-based torque Angle base Tq and an SES damping torque, and the angle-based torque may be calculated as the product of the weight torque and the weight factor. The weight torque may be determined as a value corresponding to the steering angle. The weight factor may be determined as a value corresponding to the steering angular velocity. The torque calculator 120 may retrieve a value from a table in which values corresponding to steering angles and steering angular velocities are stored to determine the weight torque and the weight factor.

The SES damping torque may be torque generated by dampers installed at two opposite ends of the steering range of the steering wheel. The angle-based torque may be set to an adjustable (or tunable) value. For example, as shown in FIG. 5, the angle-based torque may be set to a maximum value of 5 Nm and a minimum value of −5 Nm.

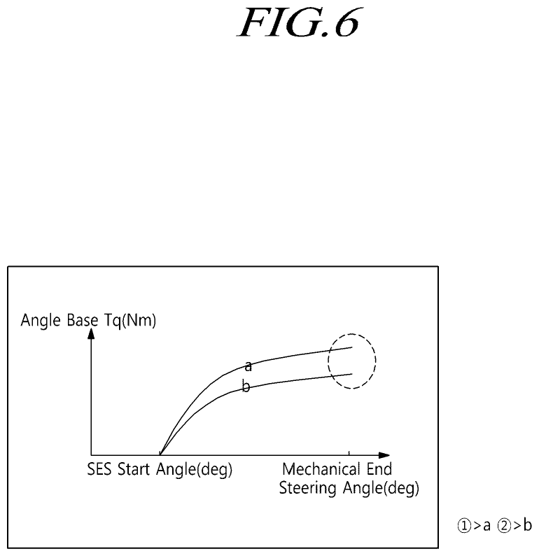

FIG. 6 is a view illustrating an angle-based torque amount according to a steering angle according to an embodiment.

Referring to FIG. 6, since the angle-based torque is calculated based on the steering angle, the steering control device 10 according to the disclosure may linearly generate the SES torque at the steering end of the steering wheel and apply a larger SES torque to the steering motor at the steering end.

Further, in the disclosure, the slope may be varied as shown in \textcircled{1} and \textcircled{2} of FIG. 6 by adjusting the weight torque amount. Here, the variable element of the torque amount may be the vehicle velocity of the host vehicle.

In other words, the SES torque may be calculated by further considering the vehicle velocity of the vehicle. For example, the weight torque may be calculated to increase as the vehicle velocity of the vehicle increases.

The section greatly affected by SES torque generation due to the above-described angle-based torque is when lock-to-lock steering is performed during creep driving.

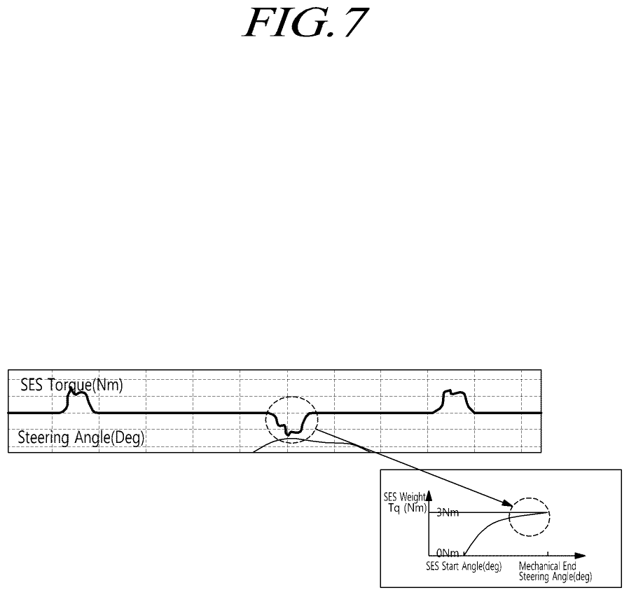

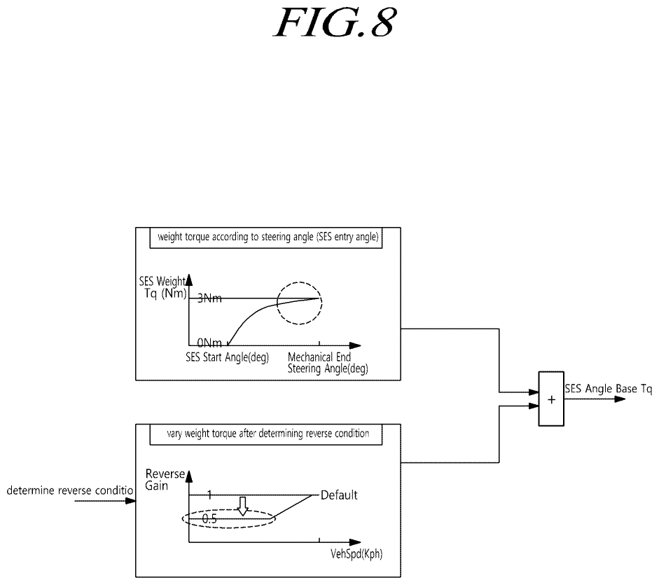

FIG. 7 is a view illustrating an example of restoring an SES torque when a steering wheel is released at an end according to an embodiment. FIG. 8 is a view illustrating an example of varying a weight torque according to a reverse condition of a steering wheel according to an embodiment.

Referring to FIG. 7, it may be identified that the SES torque is restored late during release at the steering end of the steering wheel. In other words, as the amount of SES torque applied to the end increases, restoration may be delayed when the steering wheel is released.

In order to prevent the SES torque restoration described above from being delayed, referring to FIG. 8, when it is determined that the steering wheel is reversed, the torque calculator 120 may calculate it by reducing the weight torque.

Specifically, when determining the reversion condition and determining that the steering wheel is reversed, the torque calculator may vary the weight torque amount to a predetermined gain value. For example, in FIG. 8, when the steering wheel is reversed at the steering end, the weight torque amount may be changed to 50% by decreasing the reverse gain to 0.5 for a predetermined period.

When the torque direction of the steering wheel is different from the direction of the steering angular velocity, the torque calculator 120 may determine that the steering wheel is reversed.

When the direction of the steering angle is reversed, the torque calculator 120 may determine that the steering wheel is reversed.

Accordingly, in the disclosure, since the SES torque amount is decreased, it is possible to prevent the SES torque from being restored late.

The controller 130 may output a control signal for adjusting the final torque applied to the steering motor based on the SES torque. Since the final torque is a torque calculated as the sum of the plurality of torques as described above, and the SES torque is calculated in a direction opposite to the steering by the driver, it may be in a direction opposite to the assist torque.

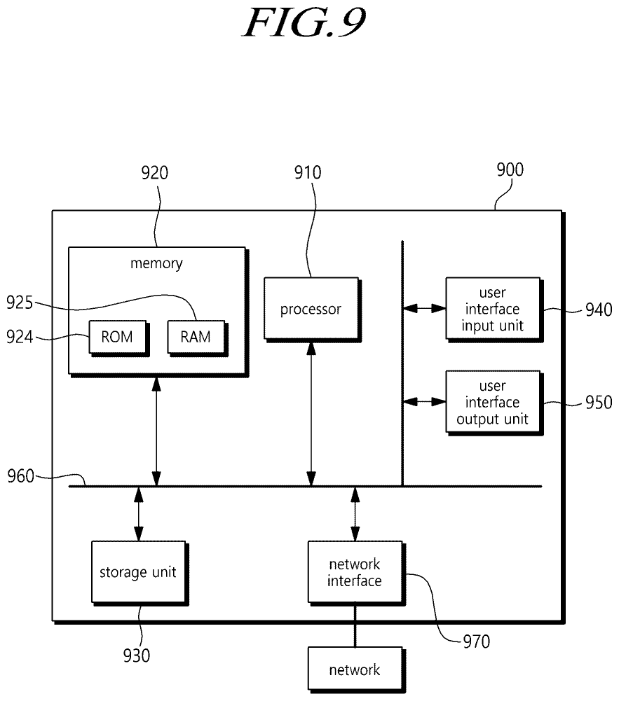

FIG. 9 is a block diagram illustrating a steering control device 10 according to another embodiment of the disclosure.

The above-described embodiments of the present invention may be implemented as, e.g., a computer-readable recording medium, in a computer system. Referring to FIG. 9, a computer system 900 such as the steering control device 10 may include at least one of one or more processors 910, a memory 920, a storage unit 930, a user interface input unit 940, and a user interface output unit 950, which may communicate with each other via a bus 960. The computer system 900 may further include a network interface 970 for connecting to a network. The processor 910 may be a central processing unit (CPU) or semiconductor device that executes processing instructions stored in the memory 920 and/or the storage unit 930. The memory 920 and the storage unit 930 may include various types of volatile/non-volatile storage media. For example, the memory 1200 may include a read only memory (ROM) 924 and a random access memory (RAM) 925.

Described below is a steering control method using the steering control device 10 capable of performing the above-described embodiments of the disclosure.

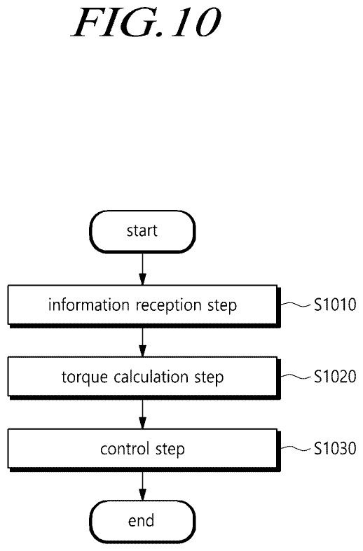

FIG. 10 is a flowchart illustrating a steering control method according to an embodiment of the disclosure.

Referring to FIG. 10, a steering control method according to an embodiment of the disclosure may comprise an information reception step S1010 receiving a steering angle of a steering wheel from a steering angle sensor, a torque calculation step S1020 calculating a soft end stop (SES) torque in a direction opposite to steering of the steering wheel if the steering angle enters an SES torque output section, and a control step S1030 outputting a control signal for adjusting a final torque applied to a steering motor based on the SES torque.

The information reception step S1010 may receive the steering angular velocity of the steering wheel from the steering angular velocity sensor and further receive the vehicle velocity of the host vehicle from the velocity sensor.

The SES torque output section may be set to a section spaced apart from a mechanical end steering angle by a predetermined angle at each of two opposite ends of the operating range of the steering wheel. The SES torque output section may be set to differ for each vehicle type.

The steering controller 10 may set an SES torque output angle instead of the SES torque output section to output the SES torque when the steering angle of the steering wheel reaches the SES torque output angle.

The SES torque may be calculated as a sum of an angle-based torque and an SES damping torque, the angle-based torque may be calculated as a product of a weight torque and a weight factor, the weight torque may be determined as a value corresponding to the steering angle, and the weight factor may be determined as a value corresponding to a detected steering angular velocity.

The SES torque may be calculated by further considering a vehicle velocity of a host vehicle. The weight torque may be calculated to increase as the vehicle velocity of the host vehicle increases.

The torque calculation step S1020 may decrease and calculate the weight torque when determining that the steering wheel is reversed. Since the SES torque according to the disclosure is output as a value larger than the conventional SES torque, the restoration of the SES torque may be delayed when the steering wheel is reversed. Accordingly, to normalize the SES torque restoration, the reversion of the steering wheel may be determined to vary the weight torque when restoring the SES torque.

When the torque direction of the steering wheel is different from the direction of the steering angular velocity, the torque calculation step S1020 may determine that the steering wheel is reversed. In other words, when the steering torque value is plus (+) and the steering velocity value is minus (−) (i.e., less than 0), the steering control device 10 may determine that the steering wheel is reversed, and when the steering torque value is—and the steering angular velocity value is + (i.e., larger than 0), the steering control device 10 may determine that the steering wheel is reversed.

When the direction of the steering angle is reversed, the torque calculation step S1020 may determine that the steering wheel is reversed.

As described above, according to the disclosure, it is possible to output the SES torque applied at a uniform position at the steering end of the steering wheel.

Further, according to the disclosure, it is possible to apply a large SES torque in a direction opposite to the steering from the steering end of the steering wheel.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed:

1. A steering control device, comprising:
a receiver receiving a steering angle of a steering wheel from a steering angle sensor;
a torque calculator calculating a soft end stop (SES) torque in a direction opposite to steering of the steering wheel when the steering angle enters an SES torque output section; and
a controller outputting a control signal for adjusting a final torque applied to a steering motor based on the SES torque.

2. The steering control device of claim 1, wherein the SES torque is calculated as a sum of an angle-based torque and an SES damping torque,
wherein the angle-based torque is calculated as a product of a weight torque and a weight factor,
wherein the weight torque is determined as a value corresponding to the steering angle, and
wherein the weight factor is determined as a value corresponding to a detected steering angular velocity.

3. The steering control device of claim 2, wherein the SES torque is calculated by further considering a vehicle velocity of a host vehicle, and
wherein the weight torque is calculated to increase as the vehicle velocity of the host vehicle increases.

4. The steering control device of claim 2, wherein the torque calculator decreases and calculates the weight torque when determining that the steering wheel is reversed.

5. The steering control device of claim 4, wherein the torque calculator determines that the steering wheel is reversed when a direction of torque of the steering wheel is different from a direction of the steering angular velocity.

6. The steering control device of claim 4, wherein the torque calculator determines that the steering wheel is reversed when a direction of the steering angle is reversed.

7. The steering control device of claim 1, wherein the SES torque output section is set to a section spaced apart from a mechanical end steering angle by a predetermined angle at each of two opposite ends of an operating range of the steering wheel.

8. A steering control method, comprising:
an information reception step receiving a steering angle of a steering wheel from a steering angle sensor;
a torque calculation step calculating a soft end stop (SES) torque in a direction opposite to steering of the steering wheel when the steering angle enters an SES torque output section; and
a control step outputting a control signal for adjusting a final torque applied to a steering motor based on the SES torque.

9. The steering control method of claim 8, wherein the SES torque is calculated as a sum of an angle-based torque and an SES damping torque,
wherein the angle-based torque is calculated as a product of a weight torque and a weight factor,
wherein the weight torque is determined as a value corresponding to the steering angle, and
wherein the weight factor is determined as a value corresponding to a detected steering angular velocity.

10. The steering control method of claim 9, wherein the SES torque is calculated by further considering a vehicle velocity of a host vehicle, and
wherein the weight torque is calculated to increase as the vehicle velocity of the host vehicle increases.

11. The steering control method of claim 9, wherein the torque calculation step decreases and calculates the weight torque when determining that the steering wheel is reversed.

12. The steering control method of claim 11, wherein the torque calculation step determines that the steering wheel is reversed when a direction of torque of the steering wheel is different from a direction of the steering angular velocity.

13. The steering control method of claim 11, wherein the torque calculation step determines that the steering wheel is reversed when a direction of the steering angle is reversed.

14. The steering control method of claim 8, wherein the SES torque output section is set to a section spaced apart from a mechanical end steering angle by a predetermined angle at each of two opposite ends of an operating range of the steering wheel.
